(19) United States
(12) Patent Application Publication
(10) Pub. No.: US 2017/0223965 A1
(43) Pub. Date: Aug. 10, 2017

(54) COMPOSITION AND APPLICATION METHOD FOR SURFACE TREATMENT OF CARPETS

(71) Applicant: INVISTA NORTH AMERICA S.A R.L., WILMINGTON, DE (US)

(72) Inventors: NATALIE M. GIBSON, COLUMBIA, SC (US); ISAAC K. IVERSON, COLUMBIA, SC (US); MICHELLE A. IVY, COLUMBIA, SC (US); FRANKLIN CARTER WEXLER, RINGGOLD, GA (US)

(73) Assignee: INVISTA NORTH AMERICA S.A R.L., WILMINGTON, DE (US)

(21) Appl. No.: 15/502,513

(22) PCT Filed: Aug. 7, 2015
(86) PCT No.: PCT/US2015/044294

§ 371 Date: Feb. 8, 2017

Related U.S. Application Data
(60) Provisional application No. 62/034,880, filed on Aug. 8, 2014.

(51) Int. Cl. A01N 59/06; B32B 5/02; A01N 25/10

(52) U.S. Cl. CPC A01N 59/06; A01N 25/10; B32B 5/028; B32B 2471/02

(57) ABSTRACT

A surface fiber treatment, carpets, carpet tiles, rugs and flooring systems prepared with the treatment and a method for applying the treatment for various purposes including pest control are provided. Pesticides such as diatomaceous earth, borax, and silicon dioxide are applied to a carpet backing in a manner that preserves fiber softness.

### FIELD OF INVENTION

The present disclosure relates to a surface fiber treatment, carpets, carpet tiles and rugs prepared with this treatment, flooring systems, and a method for applying this treatment.

### BACKGROUND

Dust mites and their feces are responsible for a large percentage of allergic reactions in the home.

Diatomaceous earth (DE) has been shown to kill a variety of insects, including ants, bedbugs, silverfish, caterpillars, crickets, termites, fleas, earwigs, beetles, ticks, dust mites, and other anthropods.

PCT Application No. PCT/GB91/00881 discloses a method for applying insect-resist active compounds, such as pyrethroids or more specifically permethrin, in or on talc, DE, ground corn cob material, chalk or polymeric powders to animal fibers or products thereof, by applying the insect-resist active compound to inert particles or incorporating the insect-resist active compound within carrier particles of polymeric particles which are low-melt/steam fusible, and applying the particles evenly over the animal fibers or products thereof. The insect-resist active compounds of this disclosure lack permanency because permethrins are volatile materials that have short active lives. Furthermore, pyrethroids show toxicity to cats, aquatic life and beneficial insects, such as bees. Concerns over these materials have created a need for less environmentally hazardous chemicals.

UK Patent Application GB2398007 discloses a method for incorporating DE powder onto the top of carpet backing with the use of polymeric film. The method involves application of diatomaceous earth in powder form to the top of a backing of carpet either before or after pile has been fitted. A hot thermoplastic polymeric material is then applied to the back of the carpet in liquid form so that it flows in and around the backing and pile fibers and wets at least a part of the surface of the DE particles so that, when cool, the thermoplastic polymeric material forms a film, binding the backing and pile fibers together and holding the DE particles at least partially exposed. This method requires great capital investment for carpet mills and drastically changes their processing procedures. Furthermore, the backing material referenced in this material is not commonly used.

Published U.S. Patent Application No. 2005/0255139 A1 discloses a polymeric composition and method of forming the polymeric composition in which a silicon dioxide based pesticidal desiccant is homogeneously dispersed throughout the polymer. Disclosed is the use of the polymeric composition in melt spun fibers made of nylon or polyester and articles formed from the fibers such as pillows, bedding furniture filler and carpeting to control dust mite growth. Examples of pesticidal desiccants disclosed in published U.S. Patent Application No. 2005/0255139 A1 include precipitated silica, DE, synthetic zeolite, montmorillonite clay, calcium oxide, calcium sulfate, and activated alumina. While examples in this patent show good efficacy against mites, the particle sizes of DE described in the patent will impact processability and reduce product yields during manufacturing. Furthermore, due to the large particle sizes, the resulting fiber is more likely to suffer from fracture and a reduced product life in flooring applications.

U.S. Pat. No. 7,238,403 lists DE as an example of an absorbent in a composite along with a binder used to line outer or inner functional surfaces such as a shelf, drawer, cabinet, refrigerator, trash receptacle, shipping container or as a backing for other surfaces such as carpeting, fabric, upholstery, drapes and the like. U.S. Pat. No. 7,287,650 and U.S. Pat. No. 8,056,733 disclose nanofiber-based structure treated with membranes that can include DE for use in articles that inhibit microbial growth. These disclosures do not teach the use of DE as a surface treatment for fibers.

Published U.S. Patent Application No. 2008/0193387 discloses DE as an example of a solid carrier used in combination with Lippia javanica essential oil in a composition applied to articles of manufacture such as carpets to kill and/or repel ectoparasites and/or pests including lice, ticks, mites, mosquitoes, ants and fleas.

Published U.S. Patent Application No. 2011/0311603 discloses a material for controlling pests comprised of a porous fabric sheet, a second fabric sheet, and a batting in contact with a pesticide which is quilted or bonded between the porous fabric sheet and the second fabric sheet. The pesticide, preferably food grade diatomaceous earth, is controllably releasable through the porous fabric sheet.

PCT Application No. PCT/US2012/059518 and published U.S. Patent Application No. 2013/0089578 disclose an insecticide including DE in a liquid mixture of water and one or more additives such as a wetting agent, dispersing agent, non-foaming agent or a thickener. The insecticide is applied in liquid form to surfaces for controlling the spread of insects.

Japanese Patent No. 5,620,750 discloses the use of desiccants, such as borate glass powders, to improve anti-mite benefits in air permeable sheets used in bedding. The borate powders are described as being dispersed in formulations and are applied as coatings onto the sheets, in combination with optional organic binders or curing agents. Silica gel, zeolite, calcium oxide, diatomaceous earth, activated carbon, activated clay, zeolite, white carbon, calcium chloride, magnesium chloride, potassium acetate, sodium borate, sodium citrate and water-absorbing polymer are cited as being useful for absorbing moisture in this disclosure. Numerous home care websites also describe a remedy for relieving carpets of residing pests by sprinkling DE on the carpet, and then vacuuming.

### SUMMARY OF THE INVENTION

An aspect of the present invention relates to surface fiber treated carpets and flooring systems.

In one nonlimiting embodiment, the surface fiber treated carpet comprises a backing scrim, carpet fibers with a top portion and bottom portion which are fitted through the backing scrim so that the bottom portion of the carpet fibers is adjacent to the backing scrim, and a surface fiber treatment applied to the backing scrim.

In one nonlimiting embodiment, the surface fiber treatment is applied to the bottom side of the backing scrim.

In one nonlimiting embodiment, the surface fiber treatment is applied to the backing scrim so that a majority of the surface fiber treatment resides on the backing scrim and bottom portion of the carpet fibers.

In one nonlimiting embodiment, a majority of the surface fiber treatment resides on the backing scrim and bottom third portion of the carpet fibers.

Another aspect of the present invention relates to pest-resistant carpet.

In one nonlimiting embodiment, the pest-resistant carpet comprises a backing scrim, carpet fibers with a top portion and bottom portion which are fitted through the backing scrim so that the bottom portion of the carpet fibers is adjacent to the backing scrim, and a pesticide applied to the backing scrim.

In one nonlimiting embodiment, the pesticide is applied to the bottom side of the backing scrim.

In one nonlimiting embodiment, the pesticide is applied in an amount and at a location in the carpet sufficient to render the carpet pest-resistant while retaining a softness substantially similar to softness of a carpet not treated with the pesticide.

In one nonlimiting embodiment, the pest-resistant carpeting comprises a backing scrim, carpet fibers with a top portion and bottom portion fitted through the backing scrim so that the bottom portion of the carpet fibers is adjacent to the backing scrim, and a pesticide applied to the backing scrim so that a majority of the pesticide resides on the backing scrim and bottom portion of the carpet fibers.

In one nonlimiting embodiment, a majority of the pesticide resides on the backing scrim and bottom third portion of the carpet fibers.

In one nonlimiting embodiment, the pesticide is applied by spraying of an aqueous suspension or solution of the pesticide to the backing scrim of the carpet.

In one nonlimiting embodiment, the pesticide is applied by foam application to the backing scrim of the carpet.

In one nonlimiting embodiment, the pest-resistant carpeting further comprises a latex backing applied to the backing scrim following application of the pesticide to the backing scrim.

In one nonlimiting embodiment, the carpet fibers comprise a polyester, a polyolefin, a polyamide and copolymers or blends thereof.

In one nonlimiting embodiment, the backing scrim comprises a thermoplastic polymer.

Another aspect of the present invention relates to flooring system comprising a backing scrim, carpet fibers fitted through the backing scrim and a pesticide applied to the backing scrim. In one nonlimiting embodiment, a carpet cushion is positioned below the backing scrim.

In one nonlimiting embodiment of this flooring system, the pesticide is applied to the bottom side of backing scrim.

In one nonlimiting embodiment of this flooring system, the pesticide is applied in an amount and at a location in the carpet sufficient to render the flooring system pest-resistant while retaining a softness of the carpet fibers substantially similar to softness of carpet fibers not treated with the pesticide.

In one nonlimiting embodiment, a majority of the pesticide resides on the backing scrim and bottom portion of the carpet fibers of this flooring system.

In one nonlimiting embodiment, the majority of the pesticide resides on the backing scrim and bottom third portion of the carpet fibers of this flooring system.

Another aspect of the present invention relates to flooring system comprising a backing scrim, carpet fibers fitted through the backing scrim, and a surface fiber treatment applied to the backing scrim. In one nonlimiting embodiment, a carpet cushion is positioned below the backing scrim.

Yet another aspect of the present invention relates to a method for producing surface fiber treated carpeting. In this method, a surface fiber treatment is applied to the backing scrim of a carpet. The carpet comprises a backing scrim and carpet fibers with a top portion and bottom portion fitted through the backing scrim so that the bottom portion of the carpet fibers is adjacent to the backing scrim.

In one nonlimiting embodiment of this method, the surface fiber treatment is applied in an amount and at a location in the carpet sufficient to render the carpet treated while retaining a softness of the carpet substantially similar to softness of carpet not treated with the surface fiber treatment.

In one nonlimiting embodiment of this method, the surface fiber treatment is applied so that a majority of the surface fiber treatment resides on the backing scrim and bottom portion of the carpet fibers.

In one nonlimiting embodiment, the surface fiber treatment is applied so that a majority of the surface fiber treatment resides on the backing scrim and bottom third portion of the carpet fibers.

In one nonlimiting embodiment, the surface fiber treatment is applied by spraying of an aqueous suspension or solution of the surface fiber treatment to the backing scrim of the carpet.

In one nonlimiting embodiment, the method further comprises applying a latex backing to the backing scrim of the carpet following application of the surface fiber treatment to the backing scrim.

### BRIEF DESCRIPTION OF THE FIGURES

FIGS. 1A and 1B are scanning electron microscopy (SEM) images of carpet fibers prepared in accordance with Example 1, where DE is applied to the top of the carpeting. FIG. 1A shows an SEM image of the top third of the pile while FIG. 1B shows an SEM image of the bottom third of the pile, with a 1500× magnification level.

FIGS. 2A through 2C are SEM images of carpet fibers prepared in accordance with Example 2 and the method of the invention, where DE is sprayed on the backing scrim. FIG. 2A is an SEM image of the top third of the pile while FIG. 2B is an SEM image of the bottom third of the pile, with a 1500× magnification level. FIG. 2C is an SEM image of the bottom third of the pile with 3500× magnification level.

FIG. 3 is an SEM image of untreated carpet fibers prepared in accordance with Example 3 at a magnification level of 1500×.

FIGS. 4A and 4B are SEM images of carpet fibers prepared in accordance with Example 4, where DE is applied to the top of the carpeting. FIG. 4A shows an SEM image of the top third of the pile while FIG. 4B shows an SEM image of the bottom third of the pile, with a 1500× magnification level.

FIGS. 5A and 5B are SEM images of carpet fibers prepared in accordance with Example 5 and the method of the invention, where DE is sprayed on the backing scrim. FIG. 5A is an SEM image of the top third of the pile while FIG. 5B is an SEM image of the bottom third of the pile, with a 1500× magnification level.

FIG. 6 is an SEM image of untreated carpet fibers prepared in accordance with Example 6 at a magnification level of 1500×.

FIGS. 7A and 7B are SEM images of an engineered or synthetic silicon dioxide approximately 1-15 microns in diameter.

FIG. 8 shows an SEM image of synthetic silicon dioxide backsprayed on 920 denier carpet.

FIGS. 9A and 9B show SEM images from a sample treated with 2.5% silicon dioxide which was exposed to 10,000 Vetterman drum cycles are shown below. These images show surface abrasion, but no critical damage to fiber structure.

FIG. 10 is an SEM image from a carpet sample not treated with silicon dioxide exposed to 10,000 Vetterman drum cycles. This image shows some wear due to dirt/latex particles.

FIG. 11 is photograph of various carpet samples subjected to two separate durability tests, hot water extraction (HWE) and vacuuming. After 5 HWE cycles and 100 vacuuming cycles, samples were dyed with a basic blue dye that reacts with silicates. The presence of the fluorochemical UNIDYNE™ TG2211 appeared to increase the durability of the DE, as seen by the deeper blue color as compared to UNIDYNE™ TG2211 or DE alone.

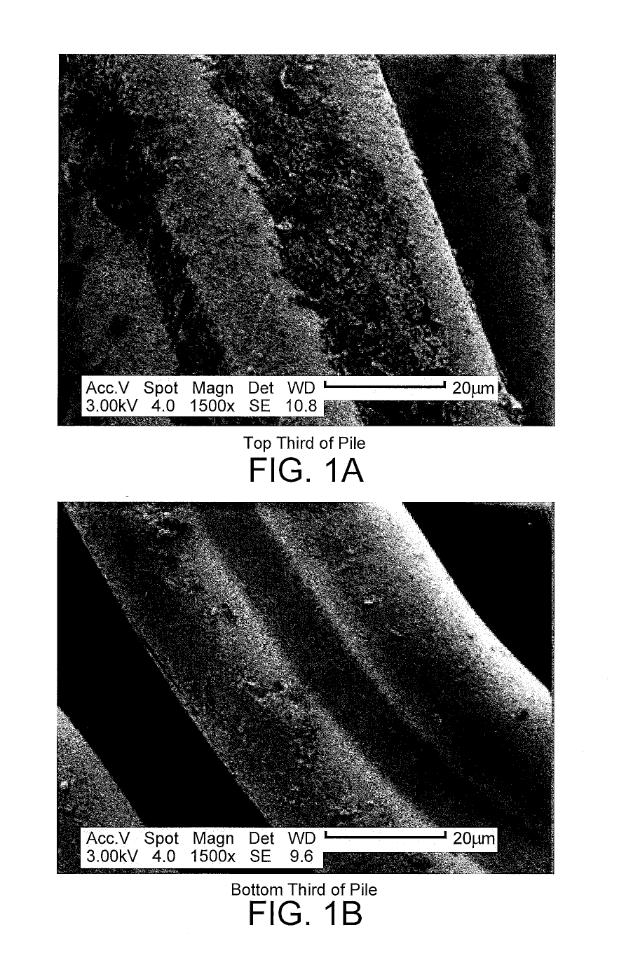

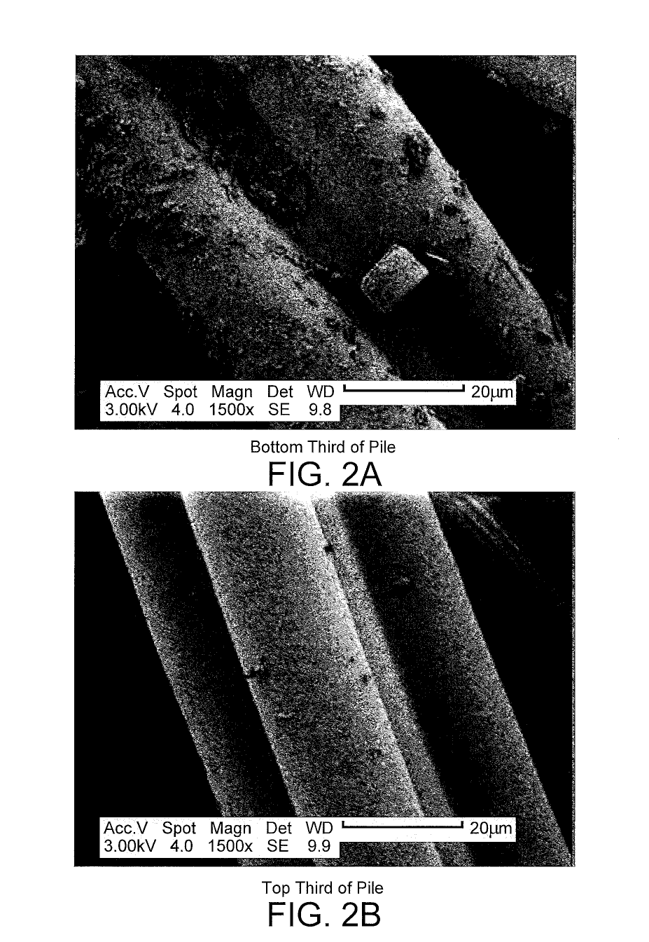

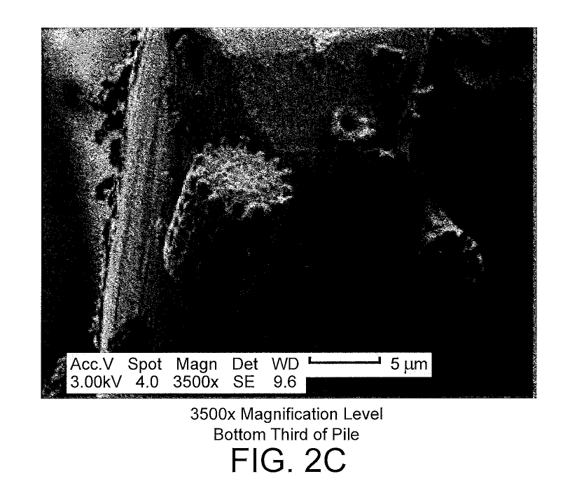

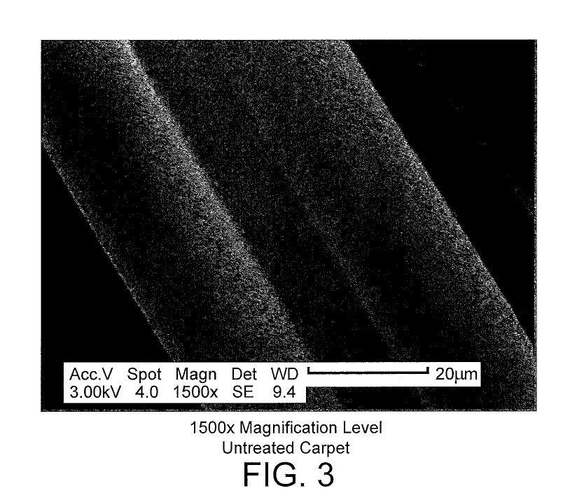

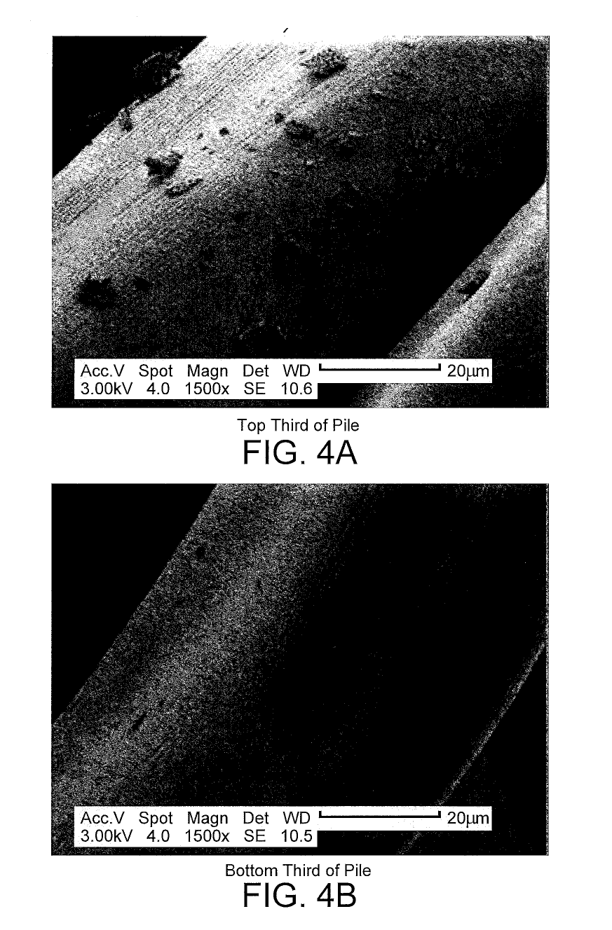

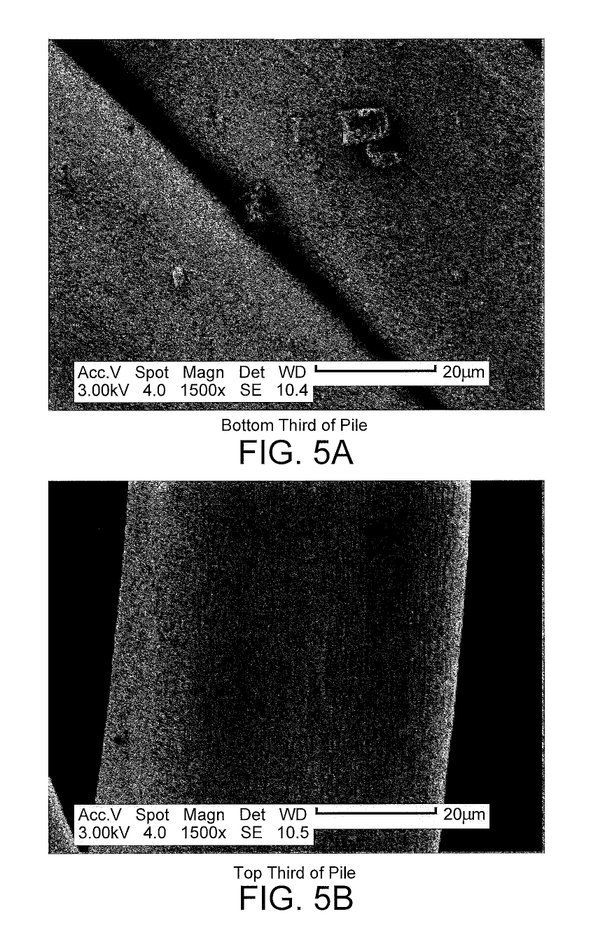

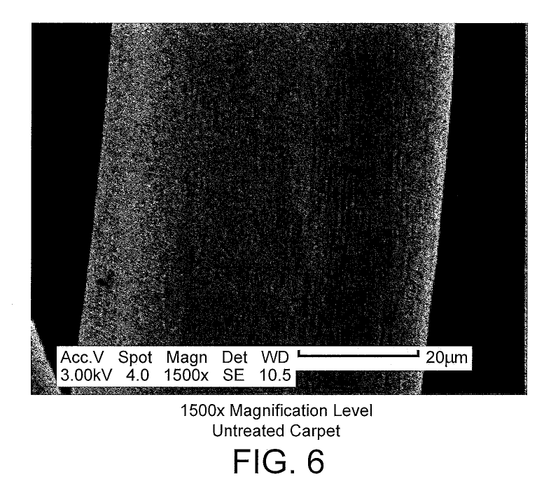

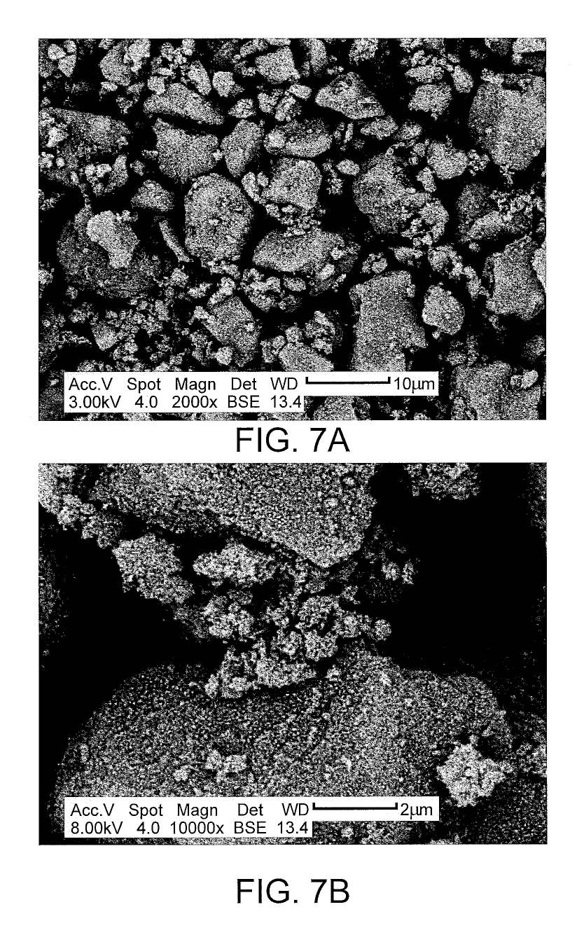

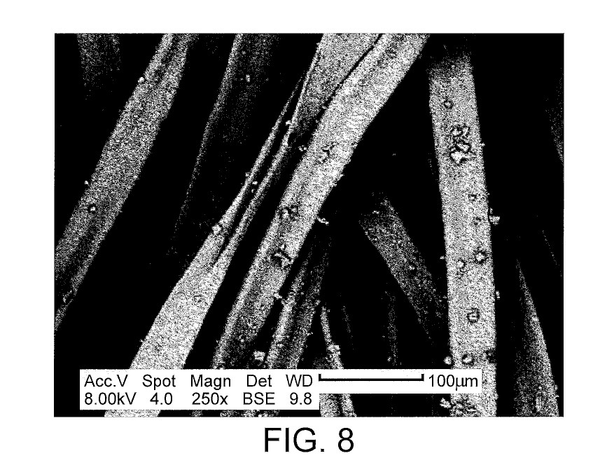

### DETAILED DESCRIPTION OF THE INVENTION

Provided by this disclosure are surface fiber treatments, carpeting, carpet tiles, rugs, flooring systems and other articles of manufacture prepared by this treatment, and methods for producing surface fiber treated carpeting, carpet tiles, rugs, flooring systems and other articles of manufacture.

In nonlimiting embodiments of the present invention, surface treatments can be utilized on fibers which can be used for pest control, mold and mildew treatment, soil release, stain resistance, water repellency, flame resistance, and oil repellency.

In nonlimiting embodiments of the present invention, the surface treatment comprises a pesticide, synthetic zeolite, silicon dioxide, surface modified silicon dioxide, montmorillonite clay, calcium oxide, calcium sulfate, activated alumina or combinations thereof.

In one nonlimiting embodiment of the present invention, the purpose of the surface fiber treatment is for pest control. By “pest,” as used herein, it is meant to include both insects as well as microbes such as, but not limited to, molds, fungi, and bacteria. In this embodiment, a pesticide is included in the surface fiber treatment. In one nonlimiting embodiment, the pesticide is diatomaceous earth (DE) or a non-toxic DE substitute. Non-toxic DE substitutes include, but are not limited to borax, boric acid, boron sodium oxide, zinc borate, disodium octoborate tetrahydrate, silicon dioxide, synthetic silicon dioxide, amorphous silicon dioxide, surface modified silicon dioxide, precipitated silica, sodium bicarbonate or combinations thereof.

In one nonlimiting embodiment of the present invention the pesticide is diatomaceous earth (DE) with a median particle size of 45 microns or less. In another nonlimiting embodiment of the present invention the pesticide is diatomaceous earth (DE) wherein a majority of the particles have a median particle size of 45 microns or less. In another nonlimiting embodiment of the present invention the pesticide is diatomaceous earth (DE) wherein substantially all of the particles have a median particle size of 45 microns or less.

In one nonlimiting embodiment of the present invention the pesticide is diatomaceous earth (DE) with a median particle size of 15 microns or less. In another nonlimiting embodiment of the present invention the pesticide is diatomaceous earth (DE) wherein a majority of the particles have a median particle size of 15 microns or less. In another nonlimiting embodiment of the present invention the pesticide is diatomaceous earth (DE) wherein substantially all of the particles have a median particle size of 15 microns or less.

In nonlimiting embodiments of the present invention, the pesticide is uncalcined DE. In another nonlimiting embodiment of the present invention, the pesticide is food grade DE. In another nonlimiting embodiment of the present invention, the DE may also be treated with chemical pesticides or surface modified to increase its efficacy as a pesticide.

In one nonlimiting embodiment of the present invention the pesticide is silicone dioxide. In another nonlimiting embodiment, the pesticide is silicon dioxide with a median particle size of 45 microns or less. In another nonlimiting embodiment of the present invention, the pesticide is silicon dioxide wherein a majority of the particles have a median particle size of 45 microns or less. In another nonlimiting embodiment of the present invention, the pesticide is silicon dioxide wherein substantially all of the particles have a median particle size of 45 microns or less.

In one nonlimiting embodiment of the present invention, the pesticide is silicon dioxide with a median particle size of 15 microns or less. In another nonlimiting embodiment of the present invention, the pesticide is silicon dioxide wherein a majority of the particles have a median particle size of 15 microns or less. In another nonlimiting embodiment of the present invention, the pesticide is silicon dioxide wherein substantially all of the particles have a median particle size of 15 microns or less.

In nonlimiting embodiments of the present invention, the pesticide is synthetic silicon dioxide. The term synthetic silicon dioxide, as used herein, may also be referred to as engineered silicon dioxide or engineered silica.

In addition to the pesticide, the surface fiber treatment further comprises an aqueous solution such as water.

Additional components which may be included in the surface fiber treatment include, but are not limited to, preservatives such as alkali salts, sulfur dioxide, sulfites, propionates, nitrites, and nitrates and binding additives or binders such as, but not limited to polymeric film formers such as polyvinyl alcohol, siliceous cross-linking agents, acrylate binders, urethane film formers and carbene/nitrene backbone biting molecules. While not being limited to any particular theory, a binding additive may be included in the event that the electrostatic attractive forces which hold the surface treatment to the carpet fiber surface are not strong enough to withstand the rigors of carpet wear and cleaning. A binder, such as those described herein, is expected to enable the surface fiber treatment to stay adhered to the carpet fibers in the presence of aggressive vacuuming, hot water extraction, excessive foot traffic, and surfactant washing.

In one nonlimiting embodiment of this invention, the surface fiber treatment is applied to the backing scrim of a carpet. In one nonlimiting embodiment, after the treatment an adhesive may be applied before the latex (or other type of adhesive) backing has been added to the carpet. In one nonlimiting embodiment, the treatment may be applied before the latex backing has been added to the carpet. In embodiments where the purpose of the surface treatment is pest-control, such application results in a pest-resistant carpet. In nonlimiting embodiments, the surface treatment may be applied by any liquid, foam, froth application known to those skilled in the art. In one nonlimiting embodiment, the treatment may be applied by spraying of the aqueous solution or suspension to the backing scrim of the carpet. Spraying allows for the backing and bottom portion of the carpet pile to be treated with the active ingredient, thus increasing the active lifetime of the treatment as the particles remain trapped in the base and do not become easily airborne or removed when using traditional home cleaning practices. Furthermore, applying the surface fiber treatment to the scrim allows for easy implementation within the carpet mill by installing a spray bar to be applied prior to the finishing process (where latex or other adhesive is applied to carpet scrim and cured). Without being limited to any particular theory, this method is believed to entrap the active ingredients of the surface fiber treatment near the carpet's base, thereby preventing the active ingredient from becoming airborne or being removed during carpet processing, and under normal cleaning practices or wear.

In another nonlimiting embodiment of the present invention, the treatment may be applied by a foaming application. In this embodiment, pad or nip rolling can also be utilized. Without being limited to any particular theory, this method is also believed to entrap the active ingredients of the surface fiber treatment near the carpet's base, thereby preventing the active ingredient from becoming airborne or being removed under normal cleaning practices.

In one nonlimiting embodiment, a majority, meaning more than 50%, of the active ingredient reside on the backing scrim and bottom portion of the carpet fibers of the carpet following application of the surface fiber treatment. In one nonlimiting embodiment, a majority, meaning more than 50%, of the active ingredient reside on the backing scrim and bottom third portion of the carpet fibers of the carpet following application of the surface fiber treatment.

The present disclosure also relates to pest-resistant carpeting, pest-resistant carpet tiles, pest-resistant rugs and pest resistant flooring systems.

Pest-resistant carpet of the present invention comprises a backing scrim. In one nonlimiting embodiment, the backing scrim comprises a thermoplastic polymer. The thermoplastic polymer used to form the backing scrim maybe selected from a thermoplastic, jute or fiberglass. Examples of thermoplastics that can be used to make backing scrims include polypropylene, polyethylene and polyester.

The pest-resistant carpeting further comprises carpet fibers with a top portion and bottom portion fitted through the backing scrim so that the bottom portion of the carpet fibers is adjacent to the backing scrim. As used herein, the term fitted refers to methods known in the art for securing synthetic fibers through a backing scrim. Methods of fitting fibers through a backing scrim include, but are not limited to tufting, weaving, and needle-punching. In one nonlimiting embodiment, the carpet fibers form a tufted carpet.

In nonlimiting embodiments of the current invention, the fibers used for carpets, carpet tiles, rugs and flooring systems comprise wool, cotton, synthetic fiber or combinations thereof. In another nonlimiting embodiment the fibers used for carpets, carpet tiles, rugs and flooring systems comprise a polyolefin, polyester polyamide or combinations thereof. In another nonlimiting embodiment of the current invention, the carpets, carpet tiles, rugs and flooring systems of the current invention may be comprised of bulked continuous filaments.

Suitable polyamides include fiber-forming polyamides known in the art to be suitable for the formation of bulked continuous filament fibers, having sufficient viscosity, tenacity, chemical stability and crystalinity to be at least moderately durable in such application. The polyamide may be selected from the group consisting of nylon 5,6; nylon 6/6; nylon 6; nylon 7; nylon 11; nylon 12; nylon 6/10; nylon 6/12; nylon DT; nylon 6T; nylon 6I; and blends or copolymers thereof. In one embodiment, the polyamide is nylon 6/6 polymer.

Suitable polyolefins include polypropylene. Suitable polyesters include fiber forming polyesters known in the art. The polyester resin may be selected from the group consisting of polyethylene terephthalate, polytrimethylene terephthalate, polybutylene terephthalate, polyethylene naphthalate, polylactic acid (PLA) and blends or copolymers thereof.

In nonlimiting embodiments, the fibers used to form the carpets, carpet tiles, rugs and flooring systems of the current invention further comprise suitable built-in stain blocking additives include those that are known to disable acid dye sites. Suitable stain blocking additives which may be used include those aromatic sulfonates and their alkali metal salts which are capable of copolymerizing with the polymeric raw materials used to form the solution dyed bulk continuous filaments of the current invention. For examples, in polyamides, such as Nylon 6,6 or Nylon 6, acid dyes sites refer to amine end groups or amide linkages which react or associate with acid dyes which result in staining. Stain blocking additives react or associate with these acid dye sites to prevent the acid dye sites from reacting or associating with acid dyes. Suitable stain blocking additives for use in polyamides are discussed in U.S. Pat. No. 5,155,178, herein incorporated by reference. Suitable stain blocking additives include, but are not limited to aromatic sulfonates and alkali metal salts thereof, such as 5-sulfoisophthalic acid, sodium salt and dimethyl-5-sulfoisophthalate, sodium salt. In one nonlimiting, embodiment, the stain blocking additive is 5-sulfoisophthalic acid, sodium salt (SSIPA). In one embodiment of the current invention, the stain blocking additive additive is 5-sulfoisophthalate. In one nonlimiting embodiment, the stain blocking additive is present in a range from about 1 to 10 percent by weight. In another nonlimiting embodiment, the stain blocking additive is present in a range from about 1 to 5 percent by weight.

In nonlimiting embodiments, the fibers used to form the carpets, carpet tiles, rugs and flooring systems of the current invention further comprises at least one conductive filament. In another embodiment, the amount of conductive filaments is sufficient to form an antistatic carpet, carpet tile, rug or flooring system. Examples of conductive filaments that can be used to impart antistatic properties to a carpet were disclosed in U.S. Pat. Nos. 4,900,495 and 4,997,712, herein incorporated by reference. In one nonlimiting embodiment of the current invention, the conductive filament is spin orientated and has a nonconductive polymeric component coextensive with a component of electrically conductive carbon dispersed in a polymeric matrix wherein the nonconductive polymeric component of the spin-oriented, conductive filaments is a melt-blend containing a major amount of a nonconductive, fiber-forming polymeric material.

In addition, the carpeting, rugs, and carpet tiles of the present invention comprises a pesticide applied to the backing scrim of the carpet. In one nonlimiting embodiment, the pesticide is applied in an amount and at a location in the carpet sufficient to render the carpet pest-resistant while retaining a softness substantially similar to softness of a carpet not treated with the pesticide. In one nonlimiting embodiment, the pesticide is applied so that a majority of the pesticide resides on the backing scrim and bottom portion of the carpet fibers. In one nonlimiting embodiment, a majority, meaning more than 50%, of the pesticide, resides on the backing scrim and bottom third portion of the carpet fibers of the carpet following application of the surface fiber treatment.

In one nonlimiting embodiment, the pesticide is diatomaceous earth (DE) or a non-toxic DE substitute. Non-toxic DE substitutes include, but are not limited to borax, boric acid, boron sodium oxide, zinc borate, disodium octoborate tetrahydrate, silicon dioxide, synthetic silicon dioxide, amorphous silicon dioxide, surface modified silicon dioxide, precipitated silica, sodium bicarbonate or combinations thereof.

In one nonlimiting embodiment of the present invention the pesticide is diatomaceous earth (DE) with a median particle size of 45 microns or less. In another nonlimiting embodiment of the present invention the pesticide is diatomaceous earth (DE) wherein a majority of the particles have a median particle size of 45 microns or less. In another nonlimiting embodiment of the present invention the pesticide is diatomaceous earth (DE) wherein substantially all of the particles have a median particle size of 45 microns or less.

In one nonlimiting embodiment of the present invention the pesticide is diatomaceous earth (DE) with a median particle size of 15 microns or less. In another nonlimiting embodiment of the present invention the pesticide is diatomaceous earth (DE) wherein a majority of the particles have a median particle size of 15microns or less. In another nonlimiting embodiment of the present invention the pesticide is diatomaceous earth (DE) wherein substantially all of the particles have a median particle size of 15 microns or less.

In nonlimiting embodiments of the present invention, the pesticide is uncalcined DE. In another nonlimiting embodiment of the present invention, the pesticide is food grade DE. In another nonlimiting embodiment of the present invention, the DE may also be treated with chemical pesticides or surface modified to increase its efficacy as a pesticide.

In one nonlimiting embodiment of the present invention the pesticide is silicone dioxide. In another nonlimiting embodiment, the pesticide is silicon dioxide with a median particle size of 45 microns or less. In another nonlimiting embodiment of the present invention, the pesticide is silicon dioxide wherein a majority of the particles have a median particle size of 45 microns or less. In another nonlimiting embodiment of the present invention, the pesticide is silicon dioxide wherein substantially all of the particles have a median particle size of 45 microns or less.

In one nonlimiting embodiment of the present invention, the pesticide is silicon dioxide with a median particle size of 15 microns or less. In another nonlimiting embodiment of the present invention, the pesticide is silicon dioxide wherein a majority of the particles have a median particle size of 15 microns or less. In another nonlimiting embodiment of the present invention, the pesticide is silicon dioxide wherein substantially all of the particles have a median particle size of 15 microns or less.

In nonlimiting embodiments of the present invention, the pesticide is synthetic silicon dioxide. The term synthetic silicon dioxide, as used herein, may also be referred to as engineered silicon dioxide or engineered silica.

In some embodiments, the pest-resistant carpet of the present invention further comprises an adhesive or additional backing to secure the fibers to the backing scrim. In one nonlimiting embodiment adhesive or additional backing is a latex backing. The latex backing may be applied after the pesticide treatment. In another nonlimiting embodiment a thermoplastic powders or films tare used to heat and bond the fibers in place. In other nonlimiting embodiments, polyvinyl chloride, vinyl acetate, polyurethane, bitumen, or rubber may be used as an adhesive or additional backing to secure the fibers to the backing scrim.

Another aspect of this disclosure relates to flooring systems comprising surface fiber treated carpet of the present invention. In one nonlimiting embodiment, the flooring system comprises a backing scrim, carpet fibers fitted through the backing scrim, and a layer of surface fiber treatment applied to the backing scrim. In one nonlimiting embodiment, a carpet cushion is positioned below the backing scrim.

In one embodiment, the surface fiber treatment is applied to the bottom side of the backing scrim of this flooring system. In one nonlimiting embodiment, the treatment is applied in an amount and at a location in the carpet sufficient to render the carpet fibers of the flooring system treated while retaining a softness, also referred to as hand, of the carpet fibers substantially similar to softness of untreated carpet fibers. In one nonlimiting embodiment, the majority of the surface fiber treatment resides on the backing scrim and bottom portion of the carpet fibers of the flooring system. In one nonlimiting embodiment, the majority of the surface fiber treatment resides on the backing scrim and bottom third portion of the carpet fibers.

The flooring systems of the present invention may further comprise an adhesive or additional backing to secure the fibers to the backing scrim. In one nonlimiting embodiment adhesive or additional backing is a latex backing. The latex backing may be applied after the pesticide treatment. In another nonlimiting embodiment a thermoplastic powders or films are used to heat and bond the fibers in place. In other nonlimiting embodiments, polyvinyl chloride, vinyl acetate, polyurethane, bitumen, or rubber may be used as an adhesive or additional backing to secure the fibers to the backing scrim.

The flooring systems of the present invention may further comprise a secondary scrim which is placed over the adhesive or additional backing to further secure the fibers to the backing scrim.

In nonlimiting embodiments of the present invention, surface treatments can be utilized on fibers which can be used for pest control, mold and mildew treatment, soil release, stain resistance, water repellency, flame resistance, and oil repellency.

In nonlimiting embodiments, the surface treatment used in flooring systems of the current invention comprises a pesticide, synthetic zeolite, montmorillonite clay, calcium oxide, calcium sulfate, activated alumina or combinations thereof.

In one nonlimiting embodiment of the present invention, the purpose of the surface fiber treatment is for pest control. In this embodiment, a pesticide is included in the surface fiber treatment. In one nonlimiting embodiment, the pesticide is diatomaceous earth (DE) or a non-toxic DE substitute. Non-toxic DE substitutes include, but are not limited to borax, boric acid, boron sodium oxide, zinc borate, disodium octoborate tetrahydrate, silicon dioxide, synthetic silicon dioxide, amorphous silicon dioxide, surface modified silicon dioxide, precipitated silica, sodium bicarbonate or combinations thereof.

In one nonlimiting embodiment of the present invention the pesticide is diatomaceous earth (DE) with a median particle size of 45 microns or less. In another nonlimiting embodiment of the present invention the pesticide is diatomaceous earth (DE) wherein a majority of the particles have a median particle size of 45 microns or less. In another nonlimiting embodiment of the present invention the pesticide is diatomaceous earth (DE) wherein substantially all of the particles have a median particle size of 45 microns or less.

In one nonlimiting embodiment of the present invention the pesticide is diatomaceous earth (DE) with a median particle size of 15 microns or less. In another nonlimiting embodiment of the present invention the pesticide is diatomaceous earth (DE) wherein a majority of the particles have a median particle size of 15 microns or less. In another nonlimiting embodiment of the present invention the pesticide is diatomaceous earth (DE) wherein substantially all of the particles have a median particle size of 15 microns or less.

In nonlimiting embodiments of the present invention, the pesticide is uncalcined DE. In another nonlimiting embodiment of the present invention, the pesticide is food grade DE. In another nonlimiting embodiment of the present invention, the DE may also be treated with chemical pesticides to increase its efficacy as a pesticide.

In one nonlimiting embodiment of the present invention the pesticide is silicone dioxide. In another nonlimiting embodiment, the pesticide is silicon dioxide with a median particle size of 45 microns or less. In another nonlimiting embodiment of the present invention, the pesticide is silicon dioxide wherein a majority of the particles have a median particle size of 45 microns or less. In another nonlimiting embodiment of the present invention, the pesticide is silicon dioxide wherein substantially all of the particles have a median particle size of 45 microns or less.

In one nonlimiting embodiment of the present invention, the pesticide is silicon dioxide with a median particle size of 15 microns or less. In another nonlimiting embodiment of the present invention, the pesticide is silicon dioxide wherein a majority of the particles have a median particle size of 15 microns or less. In another nonlimiting embodiment of the present invention, the pesticide is silicon dioxide wherein substantially all of the particles have a median particle size of 15 microns or less.

In nonlimiting embodiments of the present invention, the pesticide is synthetic silicon dioxide. The term synthetic silicon dioxide, as used herein, may also be referred to as engineered silicon dioxide or engineered silica.

In addition to the pesticide, the surface fiber treatment further comprises an aqueous solution such as water.

In nonlimiting embodiments of the current invention, the fibers used for flooring systems comprise wool, cotton, synthetic fiber or combinations thereof. In another nonlimiting embodiment the fibers used for carpets, carpet tiles, rugs and flooring systems comprise a polyolefin, polyester polyamide or combinations thereof. In another nonlimiting embodiment of the current invention, the fibers used in flooring systems of the current invention may be comprised of bulked continuous filaments.

Suitable polyamides include fiber Ruining polyamides known in the art to be suitable for the formation of bulked continuous filament fibers, having sufficient viscosity, tenacity, chemical stability and crystalinity to be at least moderately durable in such application. The polyamide may be selected from the group consisting of nylon 5,6; nylon 6/6; nylon 6; nylon 7; nylon 11; nylon 12; nylon 6/10; nylon 6/12; nylon DT; nylon 6T; nylon 6I; and blends or copolymers thereof. In one embodiment the polyamide is nylon 6/6 polymer.

Suitable polyolefins include polypropylene. Suitable polyesters include fiber forming polyesters known in the art. The polyester resin may be selected from the group consisting of polyethylene terephthalate, polytrimethylene terephthalate, polybutylene terephthalate, polyethylene naphthalate, polylactic acid (PLA) and blends or copolymers thereof.

In one nonlimiting embodiment, the backing scrim of the flooring system comprises a thermoplastic polymer.

Further provided by the present disclosure is a method for producing surface treated carpeting, carpet tiles, rugs and flooring systems. In this method, a surface fiber treatment such as, but not limited to, a pesticide is applied to the backing scrim of a carpet. In addition to the backing scrim, the carpet also comprises carpet fibers having a top portion and bottom portion fitted through the backing scrim so that the bottom portion of the carpet fibers is adjacent to the backing scrim. In one nonlimiting embodiment, the surface fiber treatment is applied in an amount and at a location in the carpet sufficient to render the carpet treated while retaining a softness, also referred to as hand, substantially similar to softness or hand of a carpet not treated with the surface fiber treatment. In one nonlimiting embodiment of this method, the surface fiber treatment is applied so that a majority of the treatment resides on the backing scrim and bottom portion of the carpet fibers. In another nonlimiting embodiment, the majority of the surface fiber treatment resides on the backing scrim and bottom third portion of the carpet fibers.

In one nonlimiting embodiment, the surface fiber treatment is applied by spraying of an aqueous suspension or solution of the surface fiber treatment to the backing scrim of the carpet. Spraying of the surface fiber treatment provides several means for adjustment of the depth of the surface fiber treatment. For example, the spray bar psi can be increased to increase depth penetration. In addition, increasing wet pick up is expected have influences on depth penetration.

Further, altering the pick count of the backing scrim can be used to impact the amount of surface fiber treatment that can easily pass through the backing scrim, with larger spacing, i.e., smaller pick counts, allowing more material to go through to the fiber, potentially increasing depth penetration. Applying a vacuum (or extractor) immediately after spraying is expected to result in more surface fiber treatment being extracted from the backing scrim to the carpet fibers. Finally, the dampness of the carpet may influence the depth of penetration for pesticidal treatment.

In another nonlimiting embodiment, the surface fiber treatment is applied by foam application of the surface fiber treatment to the backing scrim of the carpet. In this embodiment, pad or nip rolling can also be utilized. Without being limited to any particular theory, this method is also believed to entrap the active ingredients of the surface fiber treatment near the carpet's base, thereby preventing the active ingredient from becoming airborne or being removed under normal cleaning practices.

In nonlimiting embodiments of the present invention, surface treatments can be utilized on fibers which can be used for pest control, mold and mildew treatment, soil release, stain resistance, water repellency, flame resistance, and oil repellency.

In nonlimiting embodiments, the surface treatment used in flooring systems of the current invention comprises a pesticide, synthetic zeolite, montmorillonite clay, calcium oxide, calcium sulfate, activated alumina or combinations thereof.

In one nonlimiting embodiment of the present invention, the purpose of the surface fiber treatment is for pest control. In this embodiment, a pesticide is included in the surface fiber treatment. In one nonlimiting embodiment, the pesticide is diatomaceous earth (DE) or a non-toxic DE substitute. Non-toxic DE substitutes include, but are not limited to borax, boric acid, boron sodium oxide, zinc borate, disodium octoborate tetrahydrate, silicon dioxide, synthetic silicon dioxide, surface modified silicon dioxide, amorphous silicon dioxide, surface modified silicon dioxide, precipitated silica, sodium bicarbonate or combinations thereof.

In one nonlimiting embodiment of the present invention the pesticide is diatomaceous earth (DE) with a median particle size of 45 microns or less. In another nonlimiting embodiment of the present invention the pesticide is diatomaceous earth (DE) wherein a majority of the particles have a median particle size of 45 microns or less. In another nonlimiting embodiment of the present invention the pesticide is diatomaceous earth (DE) wherein substantially all of the particles have a median particle size of 45 microns or less.

In one nonlimiting embodiment of the present invention the pesticide is diatomaceous earth (DE) with a median particle size of 15 microns or less. In another nonlimiting embodiment of the present invention the pesticide is diatomaceous earth (DE) wherein a majority of the particles have a median particle size of 15 microns or less. In another nonlimiting embodiment of the present invention the pesticide is diatomaceous earth (DE) wherein substantially all of the particles have a median particle size of 15 microns or less.

In nonlimiting embodiments of the present invention, the pesticide is uncalcined DE. In another nonlimiting embodiment of the present invention, the pesticide is food grade DE. In another nonlimiting embodiment of the present invention, the DE may also be treated with chemical pesticides to increase its efficacy as a pesticide.

In one nonlimiting embodiment of the present invention the pesticide is silicone dioxide. In another nonlimiting embodiment, the pesticide is silicon dioxide with a median particle size of 45 microns or less. In another nonlimiting embodiment of the present invention, the pesticide is silicon dioxide wherein a majority of the particles have a median particle size of 45 microns or less. In another nonlimiting embodiment of the present invention, the pesticide is silicon dioxide wherein substantially all of the particles have a median particle size of 45 microns or less.

In one nonlimiting embodiment of the present invention, the pesticide is silicon dioxide with a median particle size of 15 microns or less. In another nonlimiting embodiment of the present invention, the pesticide is silicon dioxide wherein a majority of the particles have a median particle size of 15 microns or less. In another nonlimiting embodiment of the present invention, the pesticide is silicon dioxide wherein substantially all of the particles have a median particle size of 15 microns or less.

In nonlimiting embodiments of the present invention, the pesticide is synthetic silicon dioxide. The term synthetic silicon dioxide, as used herein, may also be referred to as engineered silicon dioxide or engineered silica.

In addition to the pesticide, the surface fiber treatment further comprises an aqueous solution such as water.

In nonlimiting embodiments of the current invention, the fibers used for flooring systems comprise wool, cotton, synthetic fiber or combinations thereof. In another nonlimiting embodiment the fibers used for carpets, carpet tiles, rugs and flooring systems comprise a polyolefin, polyester polyamide or combinations thereof. In another nonlimiting embodiment of the current invention, the fibers used in flooring systems of the current invention may be comprised of bulked continuous filaments.

Suitable polyamides include fiber forming polyamides known in the art to be suitable for the formation of bulked continuous filament fibers, having sufficient viscosity, tenacity, chemical stability and crystalinity to be at least moderately durable in such application. The polyamide may be selected from the group consisting of nylon 5,6; nylon 6/6; nylon 6; nylon 7; nylon 11; nylon 12; nylon 6/10; nylon 6112; nylon DT; nylon 6T; nylon 6I; and blends or copolymers thereof. In one embodiment the polyamide is nylon 6/6 polymer.

Suitable polyolefins include polypropylene. Suitable polyesters include fiber forming polyesters known in the art. The polyester resin may be selected from the group consisting of polyethylene terephthalate, polytrimethylene terephthalate, polybutylene terephthalate, polyethylene naphthalate, polylactic acid (PLA) and blends or copolymers thereof.

In one nonlimiting embodiment, the backing scrim of the flooring system comprises a thermoplastic polymer.

In some embodiments, the carpet may be heated after application of the surface fiber treatment to dry the solution.

In one nonlimiting embodiment, the method further comprises applying an adhesive or additional backing to secure the fibers to the backing scrim following application of the surface fiber treatment to the backing scrim. In one nonlimiting embodiment adhesive or additional backing is a latex backing. The latex backing may be applied after the pesticide treatment. In another nonlimiting embodiment a thermoplastic powders or films are used to heat and bond the fibers in place. In other nonlimiting embodiments, polyvinyl chloride, vinyl acetate, polyurethane, bitumen, or rubber may be used as an adhesive or additional backing to secure the fibers to the backing scrim.

When dust mites are present in carpet, they are commonly found near the carpet backing. Thus, the surface fiber treatment and carpeting of this invention, with a majority of the pesticide residing in the bottom portion of the carpet are expected to effectively control the dust mite population, thereby reducing allergic responses to dust mites. Decreases in tick, flea and bedbug populations as well as other pests, microbes, mold and mildew are also expected with this invention.

The method of surface fiber treated carpet production of the present invention is also advantageous as it requires minimal capital expense at the mill level to implement this application technique. For example, application of the surface treatment to the bottom side of the scrim can be achieved at a carpet mill with a spray bar located at any point before the latex coating apparatus. There are several places where such a spray bar could be situated. A nonlimiting example of a location for a spray bar to accomplish this task is on the continuous dye line. However, as will be understood by the skilled artisan upon reading this disclosure, the spray apparatus can be situated at any point in the line prior to the extractor slot, such that the backing of the carpet can be sprayed. The spray bar specifications, such as the size of the nozzle's opening and pump size and type, can be selected and/or adjusted so that any particulates in the treatment will not clog the lines, filters, and nozzles of the spray apparatus. A vacuum (or extractor) positioned at the face of the carpet and located on the line just after the spray apparatus can also be used. The vacuum is expected to assist with depth penetration of the surface treatment. Treatment solution may require agitation during application to keep any particles dispersed while spraying. The carpet should be completely dried before the latex coating can be applied, but may be damp or dry before applying the surface treatments of the present invention.

UK Patent Application GB2398007 discloses a method for incorporating DE powder onto the top of carpet backing with the use of polymeric film. This method involves the application of diatomaceous earth in powder form to the top of a backing of carpet as well as the use of an electrostatic charge to attract the DE powder to a film applied to the back of the backing scrim. This method requires a great capital investment for mills and drastically changes their processing procedures. The embodiments of the present invention do not include adding DE powder to the top of the backing scrim of a carpet, carpet tile, rug or flooring system. In addition, the embodiments of the present disclosure do not require the use of a film applied to the back of the backing scrim or the use of an electrostatic charge to control the location of the DE powder.

Application of the surface fiber treatment in accordance with the present invention also ensures that the hand of the carpet is not affected by any rough coating associated with surface treatments such as DE pesticides.

Use of the pesticide surface treatment of this invention, inclusive of DE and DE substitutes, also provide a non-toxic and environmentally friendly way to reduce dust mite populations in tufted carpet. Some concerns of the DE arise due to its ability to become airborne. However, the method of the present invention wherein the pesticide is adhered to the bottom portion of the carpet keeps the DE particulates in place. In one nonlimiting embodiment, during manufacturing an adhesive may be used before coating or in the DE slurry to prevent the rubbing off of any loose DE on the back of the scrim. Finally, using the method of the present invention achieves the maximum amount of pest control in carpet with the smallest quantity of pesticides such as DE when compared to methods such as sprinkling of DE on top of the carpet and addition of DE into the bulk of the fiber. Furthermore, the back-spray application allows for less “dusting-off” of the fiber as compared to top-spray application methods.

The following section provides further illustration of the articles of manufacture and processes of the present invention. These working examples are illustrative only and are not intended to limit the scope of the invention in any way.

### EXAMPLES

For examples 1-6, treated carpets were treated with a diatomaceous earth aqueous solution consisting of 4 g of diatomaceous earth, 252 g of deionized water, and 10 mg of magnesium chloride (as a preservative). The diatomaceous earth was obtained from St. Gabriel Organics. The diatomaceous earth was uncalcined and had a water absorption of greater than 145% an oil absorption of greater than 135%. This aqueous solution of diatomaceous earth was a beige color and required agitation of the solution before spray application (to prevent particulates settling out of solution).

### Example 1

### Spraying DE onto Carpet Fibers

The carpet used for testing was a residential cut-pile construction, produced from 995 denier nylon 6,6, fibers. The fibers were 2 plied together and twisted with 6 twists per inch. The final saxony styled carpet was constructed with 9/16 of an inch pile height, 13-14 stitches per inch, and ⅛ of an inch gauge. The weight of carpet was 45 ounces per square yard. The carpet was dyed light wheat beige and treated with stainblocker. The carpet was unbacked, having only the primary polypropylene backing scrim and no latex.

The diatomaceous earth solution was sprayed with a high volume low pressure (HVLP) gun onto the carpet (cut pile side up), to have a 15% wet pick up. The carpet was cured at 150° C. for 8 minutes. The hand of this carpet was noticeably rougher than the untreated control.

The carpet fibers were then looked at with scanning electron microscopy (SEM). SEM images were taken of the top third of the pile and the bottom third of the pile, with a 1500× magnification level. The SEM images show that this method results in a majority of the diatomaceous earth particulates adhering to the top third of the pile.

### Example 2

### Spraying DE onto Backing Scrim in Accordance with Present Invention

The carpet used for testing was a residential, cut-pile construction, 995 denier nylon 6,6, fibers. The fibers were 2 plied together and twisted with 6 twists per inch. The final Saxony styled carpet was constructed with 9/16 of an inch pile height, 13-14 stitches per inch, and ⅛ of an inch gauge. The weight of carpet was 45 ounces per square yard. The carpet was dyed light wheat beige and treated with stainblocker. The carpet was unbacked, having only the primary polypropylene backing scrim and no the latex.

The diatomaceous earth solution was sprayed with a HVLP gun onto the carpet polypropylene primary backing scrim (cut pile side of carpet face down), with a 15% wet pick up. The carpet was cured at 150° C. for 8 minutes. The hand of this carpet was not noticeably rougher than the untreated control.

The carpet fibers were then looked at with SEM. SEM images were taken of the top third of the pile and the bottom third of the pile, with a 1500× magnification level. The SEM images show that this method results in a majority of the diatomaceous earth particulates adhering to the bottom third of the pile.

### Example 3

### Untreated Carpet

The carpet used for testing was a residential, cut-pile construction, 995 denier nylon 6,6, fibers. The fibers were 2 plied together and twisted with 6 twists per inch. The final saxony styled carpet was constructed with 9/16 of an inch pile height, 13-14 stitches per inch, and ⅛ of an inch gauge. The weight of carpet was 45 ounces per square yard. The carpet was dyed light wheat beige and treated with stainblocker. The carpet was unbacked, having only the primary polypropylene backing scrim and no latex.

No treatment was done to the carpet. SEM images were taken of the carpet fibers, showing clean, smooth fibers at a magnification level of 1500×.

### Example 4

### Spraying DE onto Carpet Fibers

The carpet used for testing was of a looped commercial construction, produced from 1245 denier nylon 6,6 fibers, and two plied using 4.5 twists per inch. The final carped was constructed to a ¼ inch pile height using 1/10 of an inch gauge. The weight of carpet was 32 ounces per square yard. The carpet was dyed light wheat beige and treated with stainblocker. The carpet was unbacked, having only the primary polypropylene backing scrim and no latex.

The diatomaceous earth solution was sprayed with a HVLP gun onto the carpet (cut pile side up), to have a 15% wet pick up. The carpet was cured at 150° C. for 8 minutes. Hand of the carpet was not significantly affected.

The carpet fibers were then looked at with SEM. SEM images were taken of the top third of the pile and the bottom third of the pile, with a 1500× magnification level. The SEM images show that this method results in a majority of the diatomaceous earth particulates adhering to the top third of the pile.

### Example 5

### Spraying DE onto Backing Scrim in Accordance with Present Invention

The carpet used for testing was of a looped commercial construction, produced from 1245 denier nylon 6,6 fibers, and two plied using 4.5 twists per inch. The final carped was constructed to a ¼ inch pile height using a 1/10 of an inch gauge. The weight of carpet was 32 ounces per square yard. The carpet was dyed light wheat beige and treated with stainblocker. The carpet was unbacked, having only the primary polypropylene backing scrim and no latex.

The diatomaceous earth solution was sprayed with a HVLP gun onto the carpet polypropylene primary backing scrim (cut pile side of carpet face down), with a 15% wet pick up. The carpet was cured at 150° C. for 8 minutes. Hand of the carpet was not significantly affected.

The carpet fibers were then looked at with SEM. SEM images were taken of the top third of the pile and the bottom third of the pile, with a 1500× magnification level. The SEM images show that this method results in a majority of the diatomaceous earth particulates adhering to the bottom third of the pile.

### Example 6

### Untreated Carpet

The carpet used for testing was of a looped commercial construction, produced from 1245 denier nylon 6,6 fibers, and two plied using 4.5 twists per inch. The final carped was constructed to a ¼ inch pile height using a 1/10 of an inch gauge. The weight of carpet was 32 ounces per square yard. The carpet was dyed light wheat beige and treated with stainblocker. The carpet was unbacked, having only the primary polypropylene backing scrim and no latex.

No treatment was done to the carpet. SEM images were taken of the carpet fibers, showing clean, smooth fibers at a magnification level of 1500×.

For Examples 7-16, the DE used was uncalcined, had a median particle size of 15 microns or less, a water absorption of greater than 145% and an oil absorption of greater than 135%. For Examples 7-16, the silicon dioxide used was synthetic silicon dioxide obtained from Rockwell Labs, Ltd (North Kansas City, Mo.) and sold under the name CimeXa™.

### Example 7

### Dust Mite Testing

Testing was conducted using live dust mite, specifically Dermatophagoides pteronyssinus. The live mite cultures were grown and stored at 25° C. and 65% relative humidity (RH) until ready to use. Prior to testing, the number of dust mites per gram of culture was determined by weighing a portion of the culture onto an isolation dish and then counting the number of live mites using a stereo binocular microscope and camera. This information was then used to estimate the addition of approximately 50 dust mites on carpet samples for efficacy testing.

For carpet preparation and dust mite inoculation, carpet samples were cut into 10 cm×15 cm segments and the edges were pre-coated with a FLUON® polytetrafluoroethylene barrier to prevent dust mites from escaping. Samples were then preconditioned in the environmental chamber (25° C. and 65% RH) for 3 hours. All samples were conducted in triplicate. Dust mite food (0.02 grams) consisting of dried liver oxide was then rolled into the samples using a 1 kg cylindrical weight. Pressure was applied to ensure an even distribution of food to the base of the carpet. Carpets were then returned to the environmental chamber for 1 hour,

Once conditioned, a predetermined weight of the dust mite culture was added to the carpet to deliver approximately 50 mites. The carpets were then placed back into the chamber until being pulled for efficacy evaluations. During incubation, a floor lamp was placed in the passive allergen chamber and set with an automatic timer to cycle on and off every 12 hours; this process mimics the regular light cycle in households.

Heat Extraction Method (HEM) Protocol

At 5 weeks, carpets were pulled to conduct efficacy evaluations using the heat extraction method (HEM). To conduct testing a hot plate, slightly larger than the carpet sample, was turned on and brought up to 25° C. A mesh fabric, equivalent to the size of the carpet, was precut and attached to an adhesive film. The materials were pressed firmly together to ensure that the sticky side of the film was in good contact with the mesh. The mesh was used to limit the amount of food particles and dead mites that could adhere to the tape. The mesh film was then pressed onto the face of the carpets, so that it maintained good contact with the fiber tufts. The carpet sample was then placed on the 25° C. hot plate and a polystyrene block and 12 g weight was placed on the mesh to maintain a firm constant pressure throughout testing. After 10 minutes the hot plate was adjusted to 40° C. and left for an additional 10 minutes. Temperature increases took place every 10 minutes in 25° C. intervals. This was repeated until 125° C. was reached and the sample was held for a final 10 minutes. It should be noted that the temperature of the hot plate did not reflect the temperature of the carpet. Due to the 3D structure of the carpet, experiments showed that the carpet temperature did not exceed 80° C. After heat exposure, the mesh film was removed from the carpet and a second adhesive film was applied to sandwich the mesh and secure the mites for subsequent counting. For each sample, the total number of mites was counted using a stereo-binocular microscope and camera. Results are reported as the average and standard deviation of three measurements.

### Enzyme Linked Immunosorbent Assay (ELISA) Protocol

At 5 weeks, carpets were pulled to conduct efficacy evaluations using the ELISA method to quantify the amount of Der p1 protein present. The more Der p1 found in the carpet, the higher the number of dust mites. Carpet samples were placed into containers with 250 mL Phosphate Buffer Saline with 0.05% Tween (PBST) buffer solution. The containers were placed on a shaker for 24 hours at 300 rpm to aid in allergen extraction from the carpet. The extract was centrifuged for 20 minutes at 2500 rpm/5° C. and the supernatant was collected. ELISA was used to determine the amount of Der p1 protein remaining. Results are reported as the average and standard deviation of three measurements.

Results for Pilot Scale Spraying and Testing with DE

Carpet was treated with DE on a pilot scale range. The treatment was prepared by simply adding the diatomaceous earth (DE) powder to water to form a slurry. Due to the large particle size of DE, rapid sedimentation was prevented by mechanical stirring. The agitated slurry was then sprayed on underside of the carpet, i.e. the scrim, by use of a typical spray bar apparatus used to apply fluorochemical treatments in carpet mills. Concentration differences between samples were achieved by adjusting the wet pick up on the carpet. The carpet was then treated with a topical anti-soil formulation, which contained a fluorochemical (CAPSTONE® RCP, a short chain repellant and surfactant by The Chemours Company, Wilmington, Del.) and a nanoparticle fluorochemical extender. The carpets were then fully dried and latex coated.

Samples were incubated with dust mites for 5 weeks in the environmental chamber. Efficacy testing was measured via HEM and ELISA. For each test, the averages of 3 measurements are reported. Results are shown in Table 1.

TABLE 1

| | Mite count- | Total recovered |
|---|---|---|
| DE concentration | 5 week | allergen, μg |
| on weight of fiber | (HEM) | (ELISA) |
| Control - 0% | 534 ± 32 | 17.89 ± 4.15 |
| 2.5% | 9 ± 9 | 0.02 0.02 |

### Results for Pilot Scale Testing of Various Silicon Dioxides

The carpets used for testing were of a textured, cut-pile, residential style, with a 45 ounce per square yard face weight. The carpet was constructed from 920 denier fibers, which were 2-plied and tufted using 11 stitches per inch, a ⅛″ gauge, and 11/16 inches pile height. The carpet was treated with both DE and synthetic silicon dioxide powder that were mixed with deionized water prior to spraying. The mixtures were agitated by mechanical stirring to prevent sedimentation throughout the spraying process. The carpet was then treated with a topical anti-soil formulation, which contained a fluorochemical (CAPSTONE® RCP, a short chain repellant and surfactant by The Chemours Company, Wilmington, Del.) and a silxane fluorochemical extender. The carpets were then fully dried and latex coated. Results of efficacy testing in Table 2 showed various efficacy levels for different suppliers of the diatomaceous earth treatments most likely due to the differences in particle size, water absorbency, and oil absorbency of the diatomaceous earth grades used. Results in Table 2 show synthetic silicon dioxide treatment to be extremely effective at killing dust mites.

TABLE 2

| Sample type and | | |
|---|---|---|
| concentration on | Mite count- | Total recovered |
| weight of fiber | 5 week | allergen, μg |
| Control - 0% | 587 ± 112 | 166.06 ± 84.48 |
| DE sample 1 - 2.5% | 189 ± 118 | 138.32 ± 25.33 |
| DE sample 2 - 2.5% | 119 ± 135 | 137.43 ± 45.10 |
| DE sample 3 - 2.5% | 77 ± 49 | 133.65 ± 22.78 |
| Synthetic Silicon | 2 ± 2 | 111.79 27.57 |
| Dioxide - 2.5% | | |

Further, durability testing showed that after hot water extractions the treatment is still effective for dust mite kill activity, although slightly less effective than before hot water extractions were performed. Results are shown in Table 3. This indicates that the treatment is relatively durable to the hot water extraction cleaning procedures that are needed to maintain carpet during the life of the carpet.

TABLE 3

| Sample type and | | |
|---|---|---|
| concentration on | Mite count- | Total recovered |
| weight of fiber | 5 week | allergen, μg |
| Control - 0% | 766 ± 280 | 185.10 ± 24.75 |
| Control - 0% - | 895 ± 26 | 146.23 ± 19.96 |
| 3xHWE | | |
| DE 2.5% | 581 ± 207 | 56.67 ± 54.99 |
| DE 2.5% - 3xHWE | 754 ± 70 | 56.31 ± 20.14 |
| Synthetic Silicon | 6 ± 5 | 23.79 ± 22.01 |
| Dioxide - 2.5% | | |
| Synthetic Silicon | 87 ± 67 | 58.07 ± 1.89 |
| Dioxide - 2.5% - | | |
| 3xHWE | | |

### Example 8

### Performance Testing

### Staining

Acid dye stain resistance was evaluated using a procedure based on the American Association of Textile Chemists and Colorists (AATCC) Method 175, “Stain Resistance: Pile Floor Coverings.” Stains were evaluated with a visual stain rating scale (AATCC Red 40 Stain Scale) from AATCC Test Method 175; a rating of 10 signified complete stain removal whereas a rating of 1 indicated no stain removal.

### Hand/Feel of Carpet Samples

The hand or feel of the carpet sample was evaluated using relative testing methods. The person carrying out the softness evaluation used clean hands to feel the carpet, in whatever manner or method the individual chose, to determine whether the treatment in accordance with the present invention was softer, harsher, or unchanged as compared to a commercialized topical treatment. The hand panel was conducted in a blind study so that the raters could not be swayed by their perception of treatment names. The process also allowed for raters to comment on characteristics of the carpets. Ratings are provided in Table 4.

Treatment of carpets. All 920 denier carpets (described in previous examples) were top sprayed or back sprayed to achieve 2.5% owf silicon dioxide. The control carpet A, had no topical chemistries other than a stainblocker. Test carpets were sprayed with either a synthetic silicon dioxide (Carpet C and E) or diatomaceous earth (Carpet B and D). Each product was applied to carpets in a back-spray application as described in previous examples (Carpet B and C) or to the top of the carpet's tufts as typically done in industry (Carpet D and E). Samples were then evaluated for softness and other characteristics such as dusting using the hand panel technique. Ratings were from 1 to 5 where 1 is the softest and 5 is the harshest.

TABLE 4
Sample ID:
A- Control, stain-blocker only
B- Diatomaceous earth, back sprayed in accordance
with the present invention
C- Synthetic silicon dioxide, back sprayed
D- Diatomaceous earth, top sprayed
E- Synthetic silicon dioxide, top sprayed

| | Carpets (ordered softest to harshest) | | | | |
|---|---|---|---|---|---|
| Participants | A | B | C | D | E |
| Rater 1 | 1 | 2 | 3 | 4 | 5 |
| Rater 2 | 1 | 2 | 4 | 3 | 5 |
| Rater 3 | 1 | 2 | 4 | 3 | 5 |
| Rater 4 | 3 | 1 | 2 | 4 | 5 |
| Rater 5 | 1 | 3 | 2 | 4 | 5 |
| Rater 6 | 1 | 2 | 4 | 3 | 5 |
| Rater 7 | 1 | 2 | 3 | 4 | 5 |
| Rater 8 | 1 | 2 | 3 | 5 | 4 |
| Rater 9 | 1 | 2 | 3 | 4 | 5 |
| Rater 10 | 2 | 1 | 3 | 4 | 5 |
| Rater 11 | 1 | 2 | 3 | 4 | 5 |
| Rater 12 | 1 | 2 | 4 | 3 | 5 |
| Rater 13 | 1 | 2 | 3 | 4 | 5 |
| AVERAGE* | 1.23 | 1.92 | 3.15 | 3.77 | 4.92 |
| Standard | 0.60 | 0.49 | 0.60 | 0.69 | 0.28 |
| Deviation* | | | | | |

### Soiling Repellency

Soiling repellency was measured using two methods—method ASTM D1776, which outlines the method for conditioning carpet samples prior to drum soiling, and method ASTM D6540, which outlines steps required for drum soiling. Before drum soiling and after drum soiling and vacuuming, a calibrated chromameter was used to measure L*a*b* values of the carpet samples. Delta E was then calculated for the carpet sample from the equation below where for each individual carpet sample—“u” represents the value from the unsoiled carpet and “s” represents the value from the soiled carpet.

ΔE=\sqrt{(Lᵤ−Lₛ)²+(aᵤ−aₛ)²+(bᵤ−bₛ)²}

The delta E values reported in this report were averaged from five delta E measurements. The % delta E of control, which reports the accelerated soiling performance as a function of the control sample performance, enables the comparison of batch to batch delta E measurements to be made.

### End-Use Cleaning

Vacuuming and hot water extraction was conducted on carpet samples to evaluate the durability of the treatments under normal consumer care. Vacuuming was carried out using a Dyson-17 or D65 upright vacuum; the type of vacuum used was consistent within each test, but could vary between tests. Each carpet sample was vacuumed up to 100 times, where each forward and backward motion signaled 1 “time” or “pass.” Vacuuming was completed in 20 pass segments as to not overheat the carpet. For every 10 passes the carpet was turned 90°. For hot water extraction (HWE) a Sandia 3 gallon spot extractor with heat kit was used. The cleaning solution was prepared using 0.75 ounces of Flexiclean detergent to 5 gallons of water. HWE was performed by first utilizing the spray function to evenly spray the sample, followed by 1 the vacuuming function to remove any excess liquid. The combination of 1 spray and 1 vacuum was termed “1 pass,” and 3 passes were used to simulate 1 HWE cleaning cycle by a professional service. Thus, 3 HWEs mean the carpet was sprayed and vacuumed 15 times. Samples were dried a minimum of 1 hour up to 1 day between HWE cycles.

The remaining presence of SiO₂ was determined through SEM and color detection. The color detection system used a basic blue dye, Permacryl Blue NCN from Standard Dyes, Inc., that specifically reacted with the silica based nanoparticles.

### Loss on Ignition Testing

To determine the amount of inorganic silicon present on the treated carpet, as loss on ignition test was run. The carpets used for treatment in these examples were unlatexed carpet samples to avoid any inorganic mass contributions from unevenly coated calcium carbonate-rich latex. To run a loss on ignition test, a clean platinum crucible was heated up to 800±25° C. for 20 minutes in a muffle furnace. The crucible was then removed from the furnace and cooled to room temperature. The crucible was placed in a desiccator for 30 minutes. The crucible weight was then recorded. 10 g of unbacked treated carpet sample was dried in the oven at 150° C. in a weighed aluminum pan for 1 hour. The sample and pan were placed in a desiccator for 30 minutes. The crucible was placed over a Bunsen burner and the carpet sample was slowly added to the crucible until sample burning ceased. The aluminum pan was then weighed to determine the amount of sample burned in the crucible. The crucible was then placed in the muffle furnace at 800±25° C. for 1 hour. The crucible was then removed from the furnace and cooled to room temperature. The crucible was placed in a desiccator for 30 minutes and then the weight of the crucible was determined. % Inorganic material was calculated with the following equation

% Inorganic material=(Weight of ashed sample and crucible−weight of crucible)×100/(weight of sample and aluminum pan−weight of aluminum pan)

To calculate the amount of silicon in the treated sample, an untreated DE/silicon dioxide sample loss on ignition (containing inorganic content from catalysts, delusterants, and nanoparticles in the anti-soil) needs to be subtracted from the loss on ignition value from the silicon dioxide treated sample. In addition, moisture loss and small organic content loss from the DE/silicon dioxide powder needs to be taken into account. The DE/silicon dioxide powder loses anywhere from 4.7%-7.2% weight upon sample ashing. This means that a targeted concentration of 2.5% DE/silicon dioxide on fiber should have approximately 2.32%-2.38% inorganic content applied to the fiber if all of the material is applied to the fiber.

### Results for Soiling and Staining Data

Soiling and staining data are shown in the Table 5. The soiling data showed that the diatomaceous earth treatment does not impact soiling behavior of the carpet. The synthetic silicon dioxide treatment, however, had a significant soiling protection improvement from the control carpet. The diatomaceous earth and synthetic silicon dioxide treatments did not greatly impact the staining performance of the carpet fibers. The results from the loss on ignition testing are shown in the Table 5 as well. The results indicate that about half of the targeted concentration of DE or silicon dioxide was successfully adhered to the fiber and scrim surface after treatment. Some loss in the amount of the targeted concentration of silicon dioxide during processing is expected; thus the loss on ignition result obtained is a good indication the treatment was successful.

TABLE 5

| | | | | % Inorganics |
|---|---|---|---|---|
| Sample type and | | | | treated minus |
| concentration on | Soiling | Staining | | % Inorganics |
| weight of fiber | (dE) | Rating | % Inorganics | untreated |
| Control - 0% | 14.3 | 10 | 0.365% | — |
| DE Supplier 1 - 2.5% | 13.8 | 9 | 1.786% | 1.421% |
| DE Supplier 2 - 2.5% | 13.1 | 9 | 1.713% | 1.348% |
| DE Supplier 3 - 2.5% | 13.5 | 9 | 1.691% | 1.326% |
| Synthetic Silicon | 10.4 | 9 | 1.492% | 1.064% |
| Dioxide - 2.5% | | | | |

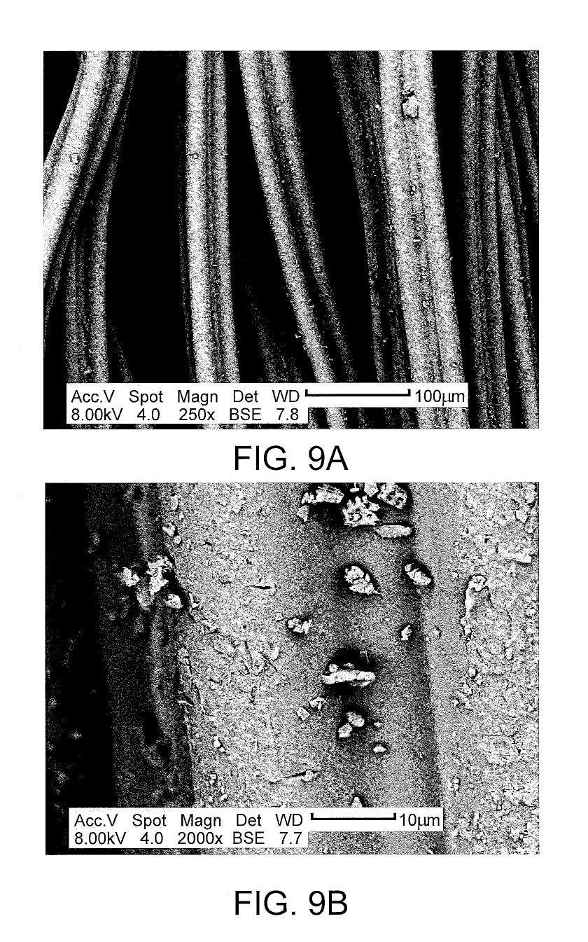

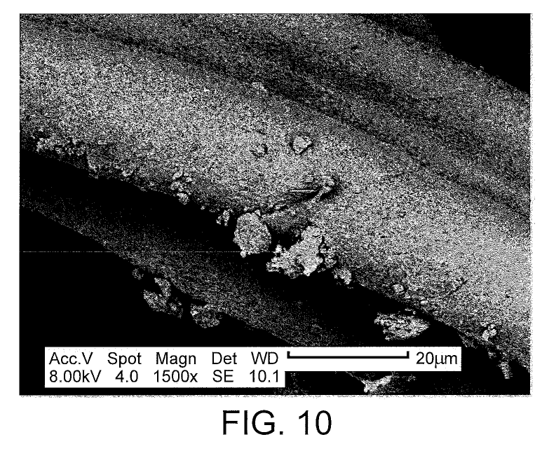

SEM images from a sample treated with 2.5% silicon dioxide which was exposed to 10,000 Vettermann drum cycles are shown in FIGS. 9A and 9B. These images show surface abrasion, but no critical damage to fiber structure. An SEM image from a sample not treated with silicon dioxide exposed to 10,000 Vettermann drum cycles is shown in FIG. 10. This image shows some wear due to dirt/latex particles.

### Example 9

### DE Top-Spray on Nylon Saxony Carpet

Carpet was treated with an aqueous DE slurry sprayed onto the face of the carpet, i.e. on the carpet tufts, rather than the scrim. In certain instances, the DE treatment was applied in conjunction with fluorochemicals and fluorochemical containing anti-soil blends. The fluorochemical used in this example was UNIDYNE™ TG2211 supplied by Daikin America Inc. (Orangeburg, N.Y.). The fluorine based additives were mixed with DE and water prior to spraying; no special mixing procedures were required. After spraying the treatment onto the carpet, samples were dried at 150° C. for 10 minutes.

After drying, an excessive amount of powder was released from the carpet samples. Since the concentration of DE applied was identical to the back-spray application, it was concluded that back-spray application has the additional advantage of holding the powder into the carpet longer. This provides less of a processing and environmental issue, reduced exposure to consumers and prolongs efficacy over the lifetime of the product.

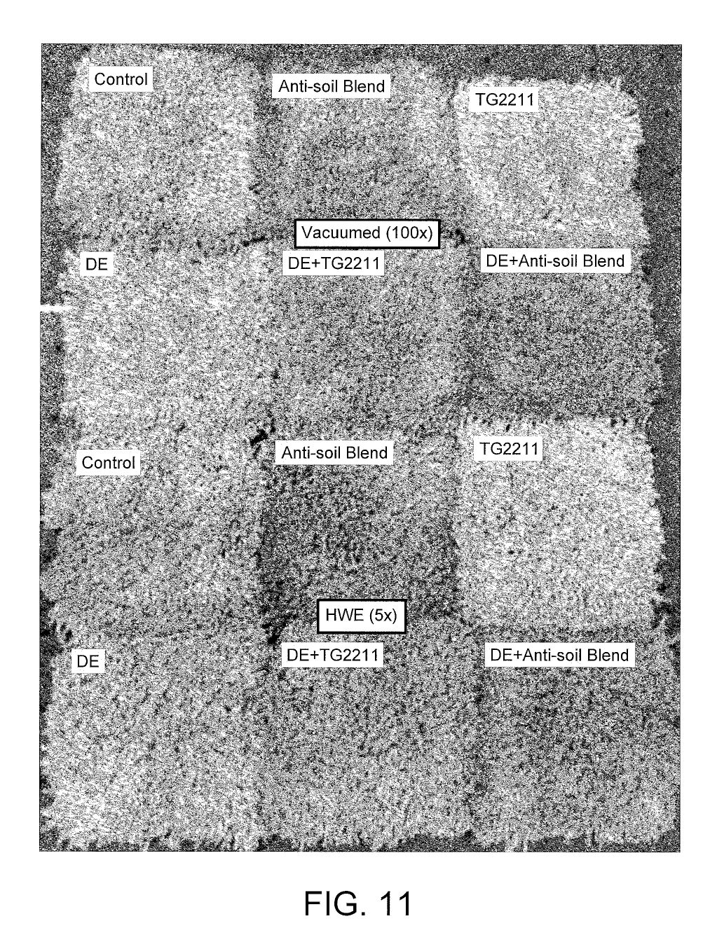

Samples were then subjected to two separate durability tests, HWE and vacuuming. After 5 HWE cycles and 100 vacuuming cycles, samples were dyed with a basic blue dye that reacts with silicates. The presence of the fluorochemical appears to increase the durability of the DE, as seen by the deeper blue color as compared to UNIDYNE™ TG2211 or DE alone. See FIG. 11. Softness testing indicated that top spray applications of DE resulted in harsher hand and more dusting as compared to previous backspray tests. When UNIDYNE™TG2211 fluorochemical was combined with DE the softness was between the control and DE only sample, in terms of harshness; dusting did not seem to be improved.

### Example 10

### Commercial Construction Carpet

In these tests, the carpet used was a commercial construction, 2490 denier, two ply, nylon 6,6 loop carpet with 4.5 twists per inch, a ¼ inch pile height, and 1/10 of an inch gauge. The weight of the carpet was 32 ounces per square yard. The carpet was dyed a light wheat beige color. The carpet was then treated with DE by simply adding DE powder to water to form a slurry. Due to the large particle size of DE, rapid sedimentation was prevented by mechanical stirring. The agitated slurry was then sprayed on the underside of the carpet, i.e. the scrim, by use of a typical spray bar apparatus used to apply fluorochemical treatments in carpet mills. Concentration differences between samples were achieved by adjusting the wet pick up on the carpet. The carpet was then treated with a topical anti-soil formulation, which contained a fluorochemical (CAPSTONE® RCP, a short chain repellant and surfactant by The Chemours Company, Wilmington, Del.) and a nanoparticle fluorochemical extender. The carpets were then fully dried and latex coated. The dust mite kill efficacy was evaluated on carpet treated with DE and carpet untreated with DE. The dust mite kill efficacy was also evaluated on carpet treated with DE that had been vacuumed 100 times. The efficacy data shown in Table 6 indicates that the treatment is effective on commercial carpet both before vacuuming and after vacuuming and therefore is durable to vacuum suction.

TABLE 6

| Sample type and | | |
|---|---|---|
| concentration on | Mite count- | Total recovered |
| weight of fiber | 5 week | allergen, μg |
| Control 0% | 453 ± 384 | 79.62 ± 61.18 |
| DE - 2.5% | 135 ± 83 | 14.65 ± 2.38 |
| DE - 2.5% - Vacuumed | 147 ± 54 | 57.89 ± 1.14 |

### Example 11

### Comparison of Top Versus Back-Spray on Polyester Carpet

The polyester carpet and DE slurry were retested using a top-spray application, i.e. the DE slurry was sprayed onto the face of the carpet, or the tufts, rather than the scrim. In certain instances, the DE treatment was applied in conjunction with fluorochemicals and fluorochemical containing anti-soil blends, i.e. CAPSTONE® RCP, a short chain repellant and surfactant by The Chemours Company, Wilmington, Del. The anti-soil chemistry selected was a combination of a fluorochemical and clay-based nanoparticles. The mixtures were made by simply blending the DE with the aqueous based anti-soil treatment prior to spraying. The results of the testing are shown in Table 7.

TABLE 7

Softness Panel (qualitative ranking)

| Treatment type | Top Spray | Back Spray |
|---|---|---|
| Control- no treatment | Soft | Soft |
| Anti-soil Blend, | Soft | Soft |
| (150 ppm F) | | |
| Capstone ® RCP only | Soft | Soft |
| (300 ppm F) | | |
| DE Slurry, | Slightly Rough | Soft |
| (2.5% owf DE) | | |
| DE + Capstone ® RCP, | Slightly Rough | Soft |
| (2.5% owf DE; 300 ppm F) | | |

### Example 12

### Solution Dyed Nylon (SDN)

The carpet used in these tests was of a textured, cut-pile, residential style, with a 45 ounce per square yard face weight. The carpet was constructed from 920 denier fibers, which were 2-plied and tufted using 11 stitches per inch, a ⅛″ gauge, and 11/16 inches pile height. The carpet was made from a solution dyed nylon sulfonated fiber, with a Burmese Gray pigment. The carpet was treated using both DE and a synthetic silicon dioxide powder that were mixed with deionized water prior to spraying. The mixtures were agitated by mechanical stirring to prevent sedimentation throughout the spraying process. The carpet was then treated with a topical anti-soil formulation, which contained a fluorochemical (CAPSTONE RCP, a short chain repellant and surfactant by The Chemours Company, Wilmington, Del.)) and a clay nanoparticle fluorochemical extender. The carpets were then fully dried and latex coated.

To determine if the DE or synthetic silicon dioxide was appropriately applied to the carpet, a loss on ignition test was run on a sample of unlatexed treated and untreated carpet to determine the percent inorganic content present on the carpet. The results from the loss on ignition testing are shown in Table 8.

TABLE 8

| Sample type and | | % Inorganics |
|---|---|---|
| target treatment | | treated minus |
| concentration on | | % Inorganics |
| weight of fiber | % Inorganics | untreated |
| SDN Control - 0% | 0.920% | — |
| SDNDE - 2.5% | 2.506% | 1.586% |
| SDN Synthetic Silicon | 2.280% | 1.360% |
| Dioxide - 2.5% | | |

The results indicate that approximately a little more than half of the silicon dioxide was successfully adhered to the fiber and scrim surface after treatment. Some amount of loss of the targeted concentration of silicon dioxide is expected during processing; thus the loss on ignition result obtained is a good indication the treatment was successful.

### Example 13

### Exhaust Applied Anti-Soil and Stainblocker

Carpet was exhaust treated at a low pH with both stainblocker and anti-soil (fluorochemical and nanoparticle). The carpet was then spray treated through the primary backing scrim with an agitated DE slurry. Dust mite pesticidal efficacy for a control carpet and the exhausted diatomaceous earth treated carpet is shown in Table 9 and shows efficacy of the diatomaceous earth treated exhausted carpet.

TABLE 9

| Sample type and | Mite count- | Total recovered |
|---|---|---|
| concentration | 5 week | allergen, μg |
| Exhaust Control - 0% | 986 ± 14 | 52.74 ± 9.18 |
| Exhaust - 2.5% | 622 ± 58 | 11.78 ± 19.62 |
| Diatomaceous Earth | | |
| Treatment | | |

### Example 14

### Polyester Saxony Construction

Polyester carpet was constructed from 1000 denier fibers, which were 2-plied and straight stitch tufted with a 1/10″ gauge and ⅝″ pile height. The final weight of the carpet was 50 oz/yd². The carpet was spray treated through the primary backing scrim with agitated slurry. The carpet was then dried and latex was applied to its underside. To determine if the DE or synthetic silicon dioxide was appropriately applied to the carpet, a loss on ignition test was run on a sample of unlatexed treated and untreated carpet to determine the percent inorganic content present on the carpet. The results from the loss on ignition testing are shown in the Table 10. The loss on ignition results indicate that approximately a third to a little more than a half of the silicon dioxide was successfully adhered to the fiber and scrim surface after treatment. Some loss in the amount of the targeted concentration of silicon dioxide is expected during processing; thus the loss on ignition result obtained is a good indication the treatment was successful. The soiling results indicate better soiling protection for the carpets treated with DE and synthetic silicon dioxide, which is consistent with previous results showing that DE and synthetic silicon dioxide treatments may improve soiling protection.

TABLE 10

| Sample type and | | % Inorganics | |
|---|---|---|---|
| target treatment | | treated minus | |
| concentration on | | % Inorganics | |
| weight of fiber | % Inorganics | untreated | dE |
| PET Control - 0% | 0.194% | — | 18.1 ± 1.23 |
| PET DE - 2.5% | 1.291% | 1.097% | 16.9 ± 1.06 |
| PET Synthetic Silicon | 1.698% | 1.504% | 14.7 ± 1.15 |
| Dioxide - 2.5% | | | |

### Example 15

### Carpet with Lower Pick Count Primary Backing

Nylon 6,6 fiber with 995 denier was 2-plied and tufted into 13 pick count primary polypropylene backing with ⅛″ gauge and 9/16″ pile height. The final tufted carpet has a face weight of 30 oz/yd2. The carpet was then dried and latex was applied to its underside. To determine if the synthetic silicon dioxide was appropriately applied to the carpet, a loss on ignition test was run on a sample of unlatexed treated and untreated carpet to determine the percent inorganic content present on the carpet. The results from the loss on ignition testing are shown in Table 11. The results indicate that approximately a third of the silicon dioxide was successfully adhered to the fiber and scrim surface after treatment; a good indication the treatment was successful. Soiling results show that the treated carpet with a low pick count soiled less, thus indicating the presence of silicon dioxide on the fiber which has been shown to contribute to soiling protection.

TABLE 11

| Sample type and | | % Inorganics | |
|---|---|---|---|
| target treatment | | treated minus | |
| concentration on | | % Inorganics | |
| weight of fiber | % Inorganics | untreated | dE |
| Low Pick Count | 0.367% | — | 16.0 ± 0.76 |
| Control - 0% | | | |
| Low Pick Count | 1.129% | 0.762% | 9.6 ± 0.63 |
| Control Synthetic | | | |
| Silicon Dioxide - 2.5% | | | |

### Example 16

### Dye Test for Detection of Silicates or Phyllosilicates on a Carpet

FIG. 11 is photograph of various carpet samples subjected to two separate durability tests, hot water extraction (HWE) and vacuuming. After 5 HWE cycles and 100 vacuuming cycles, samples were dyed with a basic blue dye that reacts with silicates. The presence of the fluorochemical UNIDYNE™ TG2211 appeared to increase the durability of the DE, as seen by the deeper blue color as compared to UNIDYNE™ TG2211 or DE alone.

### Detection Test for Silicates and Phyllosilicates

This procedure determines the presence of silicates or phyllosilicates on carpet samples using a dyeing process performed at 70° F. for 4 minutes. The dye solution to fiber ratio is 15:1. Examples of suitable phyllosilicates includes clay nanoparticles, hectorite and synthetic hectorite.

Solution Preparation: Make a 1 g/L solution of Blue NCN (Sevron/Permacryl 56%). Buffer the solution by lowering the pH to 6.90 with monosodium phosphate (MSP) then raising the pH to 7.20 (+/−0.02) with trisodium phosphate (TSP). Store dye solution in a properly labeled container. If solution is not used within 24 hours discard and make fresh.

Sample Preparation: Cut the carpet sample to fit in a container that will hold the carpet and allow for the carpet to be covered with dye solution.

Test Procedure:
1. Determine the amount of dye solution needed by weighing the carpet sample. Record the weight.
2. For unbacked carpet: dye solution (g)=carpet weight (g)×15.
3. For backed carpet: dye solution (g)=(carpet weight (g)/2)×15.
4. For carpet tiles: dye solution (g)=(carpet weight (g)/3)×15.
5. Place the dye solution in the container.
6. Place the carpet in the dye solution face down and start timing.
7. To ensure proper wetting of carpet, turn the carpet sample face up and using an acrylic brayer gently roll the carpet end to end in all four directions, then turn the carpet face down in the dye solution for the remaining time. Total time in dye bath=4 minutes.
8. Rinse the sample well in running water.
9. Extract or blot excess water and let sample air dry.
10. Compare tested sample to the control sample.

In a nonlimiting embodiment of the current invention, a method for detecting the presence of a silicates or phyllosilicate on a substrate is disclosed. The method comprises: (a) providing a substrate set, comprising test substrate and a control substrate, (b) contacting each of said test substrate, and said control substrate, with a dyestuff suitable for adhesion on a silicates or phyllosilicate substrate,(c) washing each of the test substrate and the control substrate with rinsewater, and (d) measuring the difference in dyestuff adhesion to each of test substrate, and the control substrate.

In one nonlimiting embodiment, the phyllosilicate comprises clay mineral or smectite. In another nonlimiting embodiment, the clay mineral is selected from the group consisting of dickite, fougerite, halloysite, illite, kaolinite, nacrite, nontronite, palygorskite, saponite, sepiolite, and talc. In another nonlimiting embodiment, the smectite is selected from the group consisting of aliettite, beidellite, ferrosaponite, hectorite, montmorillonite, nontronite, pimelite, saliotite, saponite, sauconite, stevensite, swinefordite, volkonskoite, yakhontovite, and zincsilite. In another nonlimiting embodiment, the phyllosilicate is synthetic hectorite.

Suitable dyestuff can be selected from is selected from the list consisting of acidic dye and basic dye. In another nonlimiting embodiment, basic dye is selected from the list consisting of Basic Yellow, Basic Red, and Basic Blue. In another nonlimiting embodiment, the basic dye is Basic Blue 94.

1. A surface fiber treated carpet comprising: a backing scrim; carpet fibers with a top portion and bottom portion, said carpet fibers fitted to the backing scrim so that the bottom portion of the carpet fibers is adjacent to the backing scrim; and a surface fiber treatment applied to the backing scrim.

2. The surface fiber treated carpet of claim 1, wherein the backing scrim has an upper side and a bottom side, and wherein the surface fiber treatment is applied to the bottom side of backing scrim.

3. The surface fiber treated carpet of claim 1 wherein the surface fiber treatment is applied in an amount and at a location in the carpet sufficient to render the carpet treated while retaining a softness substantially similar to softness of an untreated carpet.

4. The surface fiber treated carpet of claim 1 wherein a majority of the surface fiber treatment resides on the backing scrim and bottom portion of the carpet fibers.

5.-8. (canceled)

9. The surface fiber treated carpet of claim 8 wherein the pesticide is diatomaceous earth (DE), a non-toxic DE substitute, borax, boric acid, boron sodium oxide, zinc borate, disodium octoborate tetrahydrate, silicon dioxide, synthetic silicon dioxide, amorphous silicon dioxide, surface modified silicon dioxide, precipitated silica, sodium bicarbonate or combinations thereof.

10-16. (canceled)

17. A pest-resistant carpet comprising: a backing scrim; carpet fibers with a top portion and bottom portion, said carpet fitted to the backing scrim so that the bottom portion of the carpet fibers is adjacent to the backing scrim; and a pesticide applied to the backing scrim.

18. The pest-resistant carpet of claim 17, wherein the backing scrim has an upper side and a bottom side, and wherein the pesticide is applied to the bottom side of backing scrim.

19. The pest-resistant carpet of claim 17 wherein the pesticide is applied in an amount and at a location in the carpet sufficient to render the carpet pest-resistant while retaining a softness substantially similar to softness of an untreated carpet.

20. The pest-resistant carpet of any of claim 17 wherein the pesticide is applied by spraying of an aqueous suspension or solution of the pesticide to the backing scrim of the carpet.

21. The pest-resistant treated carpet of claim 17 wherein the pesticide is applied by foam application of the pesticide to the backing scrim of the carpet.

22. The pest-resistant carpet of claim 17 wherein the pesticide is diatomaceous earth (DE), a non-toxic DE substitute, borax, boric acid, boron sodium oxide, zinc borate, disodium octoborate tetrahydrate, silicon dioxide, synthetic silicon dioxide, amorphous silicon dioxide, surface modified silicon dioxide, precipitated silica or combinations thereof.

23. The pest-resistant treated carpet of claim 17 wherein the pesticide is diatomaceous earth (DE).

24. The pest-resistant carpet of claim 17 wherein the pesticide is DE with a median particle size of 45 microns or less.

25. The surface fiber treated carpet of claim 17 wherein the pesticide is synthetic silicon dioxide.

26. The surface fiber treated carpet of claim 17 wherein the pesticide is synthetic silicon dioxide with a median particle size of 15 microns or less.

27. (canceled)

28. A method for producing surface fiber treated carpeting, said method comprising applying a surface fiber treatment to a backing scrim of a carpet, wherein the carpet comprises a backing scrim and carpet fibers with a top portion and bottom portion fitted through the backing scrim so that the bottom portion of the carpet fibers is adjacent to the backing scrim.

29.-30. (canceled)

31. The method of claim 28 wherein the surface fiber treatment is applied so that a majority of the surface fiber treatment resides on the backing scrim and bottom third portion of the carpet fibers.

32. The method of claim 28 wherein the surface fiber treatment is applied by spraying of an aqueous suspension or solution of the surface fiber treatment to the backing scrim of the carpet.

33.-34. (canceled)

35. The method of claim 28 wherein the pesticide is diatomaceous earth (DE), a non-toxic DE substitute, borax, boric acid, boron sodium oxide, zinc borate, disodium octoborate tetrahydrate, silicon dioxide, synthetic silicon dioxide, amorphous silicon dioxide, surface modified silicon dioxide, precipitated silica, sodium bicarbonate, sodium aluminosilicate or combinations thereof.

36. The method of claim 28 wherein the pesticide is diatomaceous earth (DE).

37.-40. (canceled)
